(19) United States
(12) Patent Application Publication
(10) Pub. No.: US 2014/0156327 A1
(43) Pub. Date: Jun. 5, 2014

(54) COLLABORATIVE JOB DISPATCHING SYSTEMS AND METHODS

(71) Applicant: SAP AG, Walldorf (DE)

(72) Inventor: Danqing Jessie CAI, Singapore (SG)

(73) Assignee: SAP AG, Walldorf (DE)

(21) Appl. No.: 13/705,144

(22) Filed: Dec. 4, 2012

(51) Int. Cl. G06Q 10/06

(52) U.S. Cl. CPC G06Q 10/063112
USPC 705/7.14

(57) ABSTRACT

Described herein is a technology for facilitating collaborative dispatching of jobs. In accordance with one aspect, attributes of mobile resources are stored in a database. The mobile resources may be managed by a network of one or more subcontractors associated with an enterprise. In response to receiving a job posting from the enterprise, a list of one or more candidate fleets of the mobile resources may be provided, wherein the attributes of the one or more candidate fleets match requirements of the job posting. At least one candidate fleet on the list is notified of the job posting.

### TECHNICAL FIELD

The present disclosure relates generally to collaborative job dispatching systems and methods.

### BACKGROUND

Many logistics service providers are expanding their services into new territories and market segments. While doing so, logistics companies may choose to either setup their own infrastructure in the new territories, or outsource their logistics services to third parties. Setting up a new infrastructure is a very expensive and time consuming undertaking, and many companies choose to reduce the setup cost by outsourcing services to local service providers. AustraliaPost and SingPost, postal services in Australia and Singapore respectively, are two prime examples of such outsourcing business models. International courier agencies that need to deliver door-to-door parcels are adapting similar models, especially in developing countries where they do not necessarily have their own local distribution networks.

However, an efficient and integrated framework to facilitate and support the collaboration and partnership between a logistics company and external service providers does not presently exist. Most logistics marketplaces do not have the ability to match job requirements with the subcontractor's real-time situation, simply because such information is not available. Moreover, it is not practical to equip all the subcontractors with vehicle tracking devices, particularly where the business relationship between the logistics company and local service providers is loosely coupled. In addition, the effort and upfront commitment involved in external integration is huge and not justifiable in terms of cost. All these factors affect the level of transparency, sustainability and scalability of such logistics collaborative systems.

Thus, a need exists for systems, methods, and apparatuses to address the shortfalls of current technology, and to provide other new and innovative features.

### SUMMARY

A computer-implemented technology for facilitating collaborative dispatching of jobs is described herein. In accordance with one aspect, attributes of mobile resources are stored in a database. The mobile resources may be managed by a network of one or more subcontractors associated with an enterprise. In response to receiving a job posting from the enterprise, a list of one or more candidate fleets of the mobile resources may be provided, wherein the attributes of the one or more candidate fleets match requirements of the job posting. At least one candidate fleet on the list is notified of the job posting.

With these and other advantages and features that will become hereinafter apparent, further information may be obtained by reference to the following detailed description and appended claims, and to the figures attached hereto.

### BRIEF DESCRIPTION OF THE DRAWINGS

Some embodiments are illustrated in the accompanying figures. Like reference numerals in the figures designate like parts.

FIG. 1 is a block diagram illustrating an exemplary system;

FIG. 2 is a flow diagram of exemplary interactions in the system; and

FIG. 3 shows an exemplary method of matching a job with a candidate fleet.

### DETAILED DESCRIPTION

In the following description, for purposes of explanation, specific numbers, materials and configurations are set forth in order to provide a thorough understanding of the present frameworks and methods and in order to meet statutory written description, enablement, and best-mode requirements. However, it will be apparent to one skilled in the art that the present frameworks and methods may be practiced without the specific exemplary details. In other instances, well-known features are omitted or simplified to clarify the description of the exemplary implementations of present frameworks and methods, and to thereby better explain the present frameworks and methods. Furthermore, for ease of understanding, certain method steps are delineated as separate steps; however, these separately delineated steps should not be construed as necessarily order dependent or being separate in their performance.

Systems, methods, and apparatuses for facilitating collaborative dispatching of jobs are described herein. More particularly, one aspect of the present framework facilitates the collaborative dispatching of jobs to one or more subcontractors. A “subcontractor” generally refers to an external (or third party) provider of services that can be readily drawn upon by an enterprise when needed. An exemplary subcontractor includes a logistics company, operator or agent with a fleet of one or more mobile resources (e.g., trucks, vans, buses, etc.) capable of transporting goods or persons.

In accordance with one aspect, a real-time and dynamic jobs planning and dispatching framework is provided. The framework matches real-time job requirements with individual subcontractor's mobile resources' real-time attributes. For example, in the case of logistics jobs, the present framework matches real-time delivery job requirements (e.g., goods type, amount and delivery time, etc.) with attributes of individual subcontractor's mobile resources (e.g., real-time status information, access rules, etc.). Once a match is found, the present framework notifies the matching subcontractor and/or associated mobile resources of the job opportunity, and requests confirmation of job acceptance.

The present framework allows an enterprise to collaborate with subcontractors in an efficient manner through a shared cross-company network to jointly plan and fulfill job orders. For example, a logistics enterprise may employ the present framework to collaborate with third party logistics service providers to jointly fulfill contracted deliveries. This allows the logistics enterprise to expand to new markets and territories by partnering with local service providers (or subcontractors) without incurring the large expense of setting up its own infrastructure. It further allows the logistics enterprise to provide on-time deliveries and improve productivity through partnerships that are transparent, sustainable and scalable. These, and other exemplary features, will be discussed in more details in the following sections.

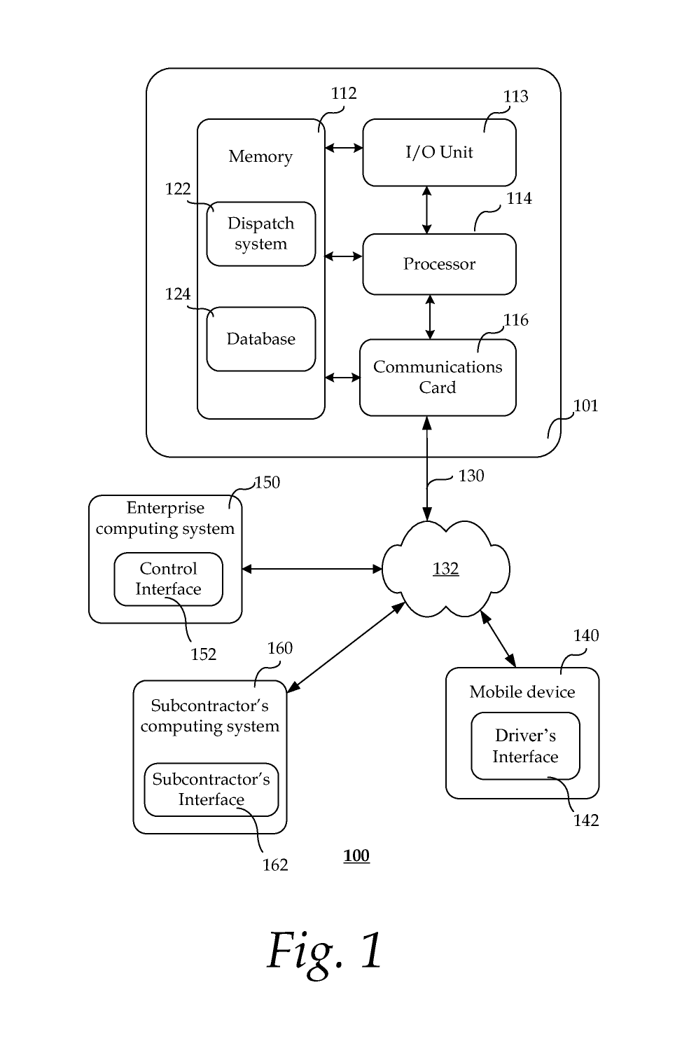

FIG. 1 is a block diagram illustrating an exemplary system 100 that implements the framework described herein. The system 100 generally includes a server 101, a mobile device 140, an enterprise computing system 150, a subcontractor's computing system 160, at least some of which are communicatively coupled via a network 132. Although shown as a single machine, the server 101 may include more than one server, such as a server pool. Two or more mobile devices 140, enterprise computing systems 150 and/or subcontractor's computing systems 160 may also operate in the system 100. The server 101 may be implemented from a website or cloud, and deliver content to one or more applications.

Turning to the server 101 in more detail, it may include a non-transitory computer-readable media or memory 112, a processor 114, an input-output unit 113, and a communications card 116. Non-transitory computer-readable media or memory 112 may store machine-executable instructions, data, and various programs, such as an operating system (not shown), web services, a dispatch system 122 and database 124 for implementing the techniques described herein, all of which may be executable by processor 114. As such, the server 101 is a general-purpose computer system that becomes a specific purpose computer system when executing the machine-executable instructions. Alternatively, the dispatch system 122 and/or database 124 described herein may be implemented as part of a software product or application, which is executed via the operating system. The application may be integrated into an existing software application, such as an add-on or plug-in to an existing application, or as a separate application. The existing software application may be a suite of software applications. It should be noted that the dispatch system 122 and/or database 124 may be hosted in whole or in part by different computer systems in some implementations. Thus, the techniques described herein may occur locally on the server 101, or may occur in other computer systems and be reported to server 101.

Each computer program may be implemented in a high-level procedural or object-oriented programming language, or in assembly or machine language if desired. The language may be a compiled or interpreted language. The machine-executable instructions are not intended to be limited to any particular programming language and implementation thereof. It will be appreciated that a variety of programming languages and coding thereof may be used to implement the teachings of the disclosure contained herein.

Generally, memory 112 may include any memory or database module for storing data and program instructions. Memory 112 may take the form of volatile or non-volatile memory including, without limitation, magnetic media, optical media, random access memory (RAM), read-only memory (ROM), removable media, or any other suitable local or remote memory component. Memory 112 may store various objects or data, including classes, frameworks, applications, backup data, business objects, jobs, web pages, web page templates, database tables, repositories storing business and/or dynamic information, and any other appropriate information including any parameters, variables, algorithms, instructions, rules, constraints, or references thereto associated with the purposes of the server 101.

In some instances, memory 112 can function as an in-memory database 124 to allow seamless access to and propagation of high volumes of data in real-time. Parallel processing may further be achieved by using a multicore processor 114 in conjunction with the in-memory database 124. The in-memory database 124 is a database management system that relies primarily on a system's main memory for efficient computer data storage. More particularly, the data in the in-memory database 124 resides in volatile memory and is not persistently stored on a hard drive, thereby allowing the data to be instantly accessed and scanned at a speed of several megabytes per millisecond.

Column-based data storage may further be implemented in the in-memory database 124, where data tables are stored as columns of data, in sequence and in compressed memory blocks. This may facilitate faster aggregation of data when calculations are performed on single columns. Alternatively, row-based data storage is also possible. In some implementations, instead of updating entire rows, only fields that have changed will be updated. This avoids having to lock entire data tables during updates to prevent conflicting modifications to a set of data. High levels of parallelization may be achieved, which is critical to real-time processing of live data streams and performing constant and substantially simultaneous updates.

Server 101 may be communicatively coupled to an input device (e.g., keyboard, touch screen or mouse) and a display device (e.g., monitor or screen) via the I/O unit 113. In addition, Server 101 may also include other devices such as a communications card or device (e.g., a modem and/or a network adapter) for exchanging data with a network using a communications link 130 (e.g., a telephone line, a wireless network link, a wired network link, or a cable network), and other support circuits (e.g., a cache, power supply, clock circuits, communications bus, etc.). In addition, any of the foregoing may be supplemented by, or incorporated in, application-specific integrated circuits.

Server 101 may operate in a networked environment using logical connections to one or more mobile devices 140, enterprise computing systems 150, subcontractor's computing systems 160 over one or more intermediate networks 132. These networks 132 generally represent any protocols, adapters, components, and other general infrastructure associated with wired and/or wireless communications networks. Such networks 132 may be global, regional, local, and/or personal in scope and nature, as appropriate in different implementations. The network 132 may be all or a portion of an enterprise or secured network, while in another instance, at least a portion of the network 132 may represent a connection to the Internet. In some instances, a portion of the network may be a virtual private network (VPN). The network 132 may communicate, for example, Internet Protocol (IP) packets, Frame Relay frames, Asynchronous Transfer Mode (ATM) cells, voice, video, data, and other suitable information between network addresses. The network 132 may also include one or more local area networks (LANs), radio access networks (RANs), metropolitan area networks (MANs), wide area networks (WANs), all or a portion of the World Wide Web (Internet), and/or any other communication system or systems at one or more locations.

In general, mobile device 140 may be any computing device operable to connect to or communicate with at least the server 101, the enterprise computing system 150, the subcontractor's computing system 160 and/or the network 132 using a wired or wireless connection. In some implementations, the mobile device 140 may be equipped with Global Positioning Systems (GPS) or other form of location identification and reporting technology. Such technology may enable the server 101 to locate the mobile device 140 or its user (e.g., vehicle driver, other individual agent or mobile resource) with pin-point accuracy. In some instances, the mobile device 140 may be a cellular phone, personal data assistant (PDA), smartphone, laptop, tablet personal computer (PC), e-reader, media player, a digital camera, a video camera, Session Initiation Protocol (SIP) phone, touch screen terminal, enhanced general packet radio service (EGPRS) mobile phone, navigation device, an email device, a game console, any other suitable wireless communications device capable of performing a plurality of tasks including communicating information using a radio technology, or a combination of any two or more of these devices.

The mobile device 140 may include an input device, a display, a processor, a memory or non-transitory computer-readable media, an interface card, and so forth. In some implementations, the memory stores a driver's interface 142. A mobile resource may, for instance, interact with the driver's interface 142 to bid for, accept, reject, or otherwise respond to, a job posting issued by server 101. The mobile resource may also specify their desired location of service, which may be different from their actual location at the time of receiving the service request. The driver's interface 142 may be, for example, a mobile application. The driver's interface 142 may be written in any programming language, such as a C, C++, C#, Java, JavaScript, Visual Basic, assembler, Perl, HTML5, any suitable version of 4GL, as well as others, including a publicly exposed application programming interface (API).

The enterprise computing system 150 and the subcontractor's computing system 160 may be any electronic computer devices operable to receive, transmit, process, and store any appropriate data associated with the system 100 of FIG. 1. Although shown as single machines, the enterprise computing system 150 and the subcontractor's computing system 160 may be embodied as multiple machines. The enterprise computing system 150 and the subcontractor's computing system 160 may each be, for example, a personal computer, a desktop, a laptop, a touch screen terminal, a workstation, a network computer, a server, etc. One or more processors within these or other devices, or any other suitable processing device, and typically includes many or all of the elements described above relative to server 101. The enterprise computing system 150 and the subcontractor's computing system 160 may also include one or more instances of non-transitory computer readable storage media or memory devices (not shown).

The memory of the enterprise computing system 150 may include a control interface 152 suitable for interacting with the dispatch system 122 over the network 132. The memory of the subcontractor's computing system 160 may also include a subcontractor's interface 162 suitable for interacting with the dispatch system 122 over the network 132. In some implementations, the control interface 152 and subcontractor's interface 162 are written in any programming language that enables them to interact with a web browser, such as a C, C++, Java, Visual Basic, assembler, Perl, any suitable version of 4GL, as well as others.

Generally, the enterprise computing system 150 may be located at, controlled or otherwise accessed by an enterprise, such as an international freight company or other logistics company that does not necessarily have locally-based mobile resources to fulfill service requests by its customers. An enterprise user may interact with the control interface 152 to process and/or display information related to service-related interactions (e.g., service requests, bids, management, reporting, etc.).

The subcontractor's computing system 160 may be located at, controlled or otherwise accessed by a business that has partnered with the enterprise, such as a third-party service provider or logistics company with its own locally-based network of mobile resources. The subcontractor may employ, outsource to or otherwise subcontract with one or more mobile resources that are capable of fulfilling service requests from the enterprise's customers. The subcontractor may interact with the subcontractor's interface 162 to, for instance, subscribe to, or register as, a service provider, discover service requests, bid, reserve and/or fulfill service requests, define preferences (e.g., preferred area or route of service), provide static access rules, provide information about their mobile resources (e.g., number of vehicles, vehicle types, capacities, gas mileage, etc.). These and other exemplary features will be described in more detail in the following sections.

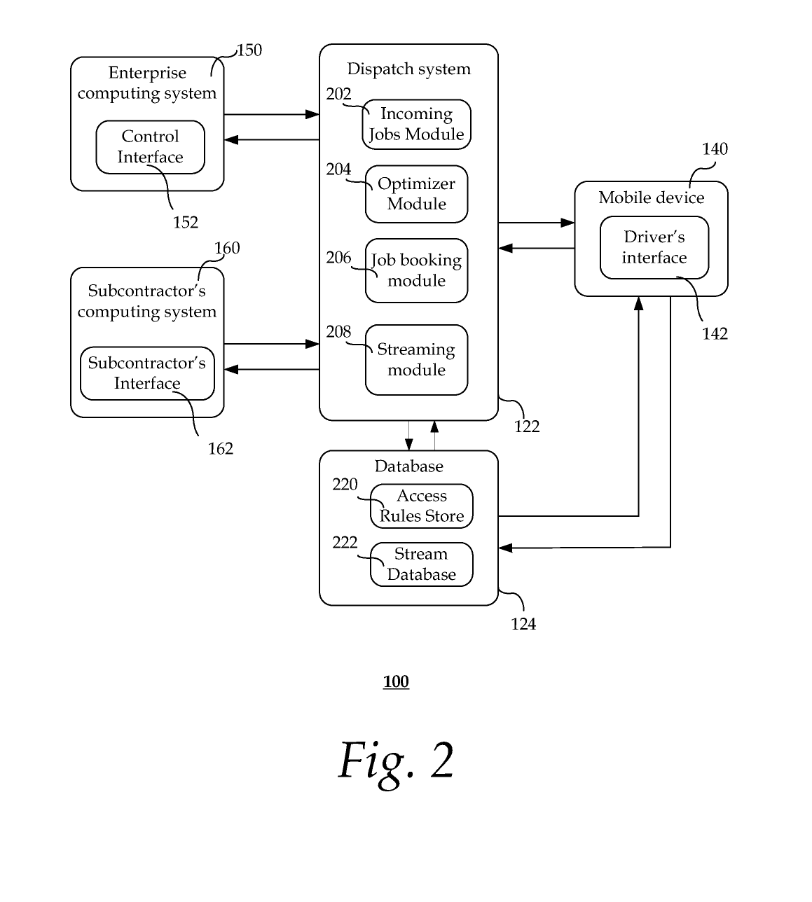

FIG. 2 is a flow diagram of exemplary interactions in the system 100. As shown, the dispatch system 122 and/or database 124 may include one or more exemplary modules or components that are computer readable code or data, or computer executable instructions for performing one or more of the functions described herein. Exemplary modules of the dispatch system 122 may include an incoming jobs module 202, an optimizer module 204, a job booking module 206 and a streaming module 208. Likewise, the database 124 may include exemplary components such as an access rules store 220 and a stream database 222. Other implementations may include fewer or greater modules or components incorporating some or all functionalities associated with the modules or components described herein.

In accordance with one implementation, the mobile device 140 updates dynamic attributes stored in the stream database 222. Dynamic attributes include, for instance, location data (e.g., exact position or GPS coordinates, velocities, directions, altitudes, etc.), other types of sensor data (e.g., temperature within the truck), available capacity data, temporal data (e.g., travel time to the next job site), graphical data (e.g., pictures of current load and/or location, etc.), and so forth.

The updating may be performed in real-time by sending real-time status information to the stream database 222. The mobile device 140 may send the real-time status information with or without manual intervention. For example, the mobile resource may authorize the mobile device 140 to periodically and automatically update the stream database 222 with real-time status information. The real-time status information of the dynamic attributes may be received from one or more sensors (e.g., location detection device or GPS receiver) associated with the mobile device 140 and transmitted by the driver's interface 142.

In addition, the subcontractor may interact with the subcontractor's interface 162 to create and/or maintain one or more access rules that are stored in the access rules store 220. The access rules define one or more static attributes associated with the mobile resources owned or managed by the subcontractor. For example, the access rules may specify, for each of the subcontractor's mobile resource, the category of goods (e.g., refrigerated food, dry goods, etc.) that may be transported, vehicle information (e.g., capacity, model, gas mileage, etc.), preferences (e.g., preferred regions or routes of operation), Media Access Control (MAC) address or other types of unique identifiers of the mobile device 140 associated with the mobile resource, driver's personal profile information (e.g., contact information, license data), and so forth.

In some implementations, an enterprise may post one or more jobs via the control interface 152 to the incoming jobs module 202. The jobs may be posted in response to one or more service requests submitted by one or more customers of the enterprise over a client device, computer or server (not shown). For example, a customer may provide a service request via a mobile application using a mobile phone or other type of customer interface that is communicatively coupled with the enterprise computing system 150. Each job posting may specify job requirements, such as requested locations and times of pickup and dropoff, information of goods to be transported (e.g., types, weight, size, quantity, value, etc.), delivery time window (e.g., express, normal, etc.), priority level based on one or more factors (e.g., Service Level Agreement), etc. The job posting may also include other types of information, such as customer information (e.g., name, company, payment mode, etc.), payment information (e.g., cash, amount, type, etc.), and so forth.

Once the incoming jobs module 202 receives the job postings, it communicates them to the optimizer module 204. The optimizer module 204 may query the stream database 222 and access rules store 220 for static (e.g., access rules) and/or dynamic attributes (e.g. location information) of available mobile resources. The mobiles resources may be managed by a network of one or more subcontractors associated with the enterprise. Based on the static and/or dynamic attributes, the optimizer module 204 performs a matching process to determine a suggestions list of candidate fleets of one or more mobile resources to fulfill the job or service request.

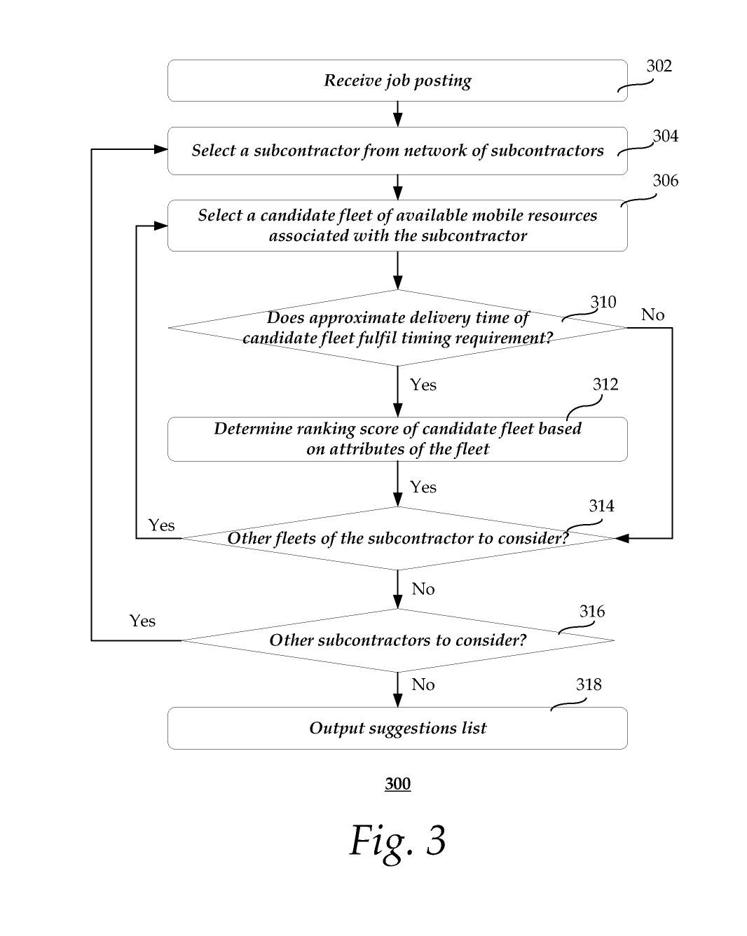

The optimizer module 204 may further sort the suggestions list in accordance with one or more sorting parameters. The sorting parameters include, for instance, number-of-empty-miles-saved, individual preference(s), overall carbon impact, proximity to the pickup location, approximate delivery (or arrival) time, service quality ratings, etc., as will be described in more detail later. In one implementation, a ranking score is determined for each candidate fleet of mobile resources on the list based on a sorting parameter. In implementations where there are multiple sorting parameters, the ranking scores may be averaged to determine the overall ranking score of each candidate fleet. The suggestions list may then be sorted in accordance with the overall rank of each candidate fleet. More details of the matching and ranking process will be discussed with reference to FIG. 3.

The optimizer module 204 may then communicate the suggestions list to the job booking module 206. Alternatively, the optimizer module 204 communicates the highest ranked candidate fleet of mobile resources to the job booking module 206. The job booking module 206 sends one or more job notifications to the candidate fleets on the list to inform them of the job opportunity. The job notification may be sent to the driver's interface 142 and/or the subcontractor's interface 162 to inform the respective parties. The job notification may include job information, such as pickup and dropoff times and locations, goods information (e.g., type, size, etc.), and so forth. The job notifications may be sent in the form of, for example, text messages or push notifications, or any other form of messaging channel.

In some implementations, the one or more job notifications are transmitted sequentially in accordance with the order of the sorted list. For instance, higher ordered (or ranked) candidate fleet may be sent the job notification earlier than lower ordered (or ranked) candidate fleet. This allows the higher ordered candidate fleet the opportunity to accept or reject the job first. If the job is rejected or no response is received within a predetermined time period, the next candidate fleet on the suggestions list may be notified. Alternatively, the job notifications may be sent in parallel (e.g., concurrently) to the one or more candidate fleets on the suggestion list. This allows the job to be assigned to the first mobile resource to accept the job.

Once one or more job notifications are sent out, the job booking module 206 may seek confirmation of job acceptance from the notified candidate fleet. For example, the job booking module 206 may receive a booking confirmation message from a mobile device 140 associated with the notified mobile resource. The booking confirmation message indicates that the notified mobile resource is willing to fulfill the job or service request. In some implementations, where multiple booking confirmation messages are received, the job is assigned to the mobile resource who responded first.

The job booking module 206 then communicates the confirmed booking information to the control interface 152. The confirmed booking information may include, for example, current location and information about the assigned mobile resource, estimated time of arrival, etc. The control interface 152 may notify the enterprise's customer, who submitted the service request, of the booking confirmation. Once the assigned mobile resource picks up the job at the pickup location, the streaming module 208 may track the current location of the selected mobile resource and feed the tracking information to the control interface 152 for display. The control interface 152 may also communicate the tracking information to the enterprise's customer until proof of delivery is collected.

FIG. 3 shows an exemplary method 300 of matching a job with a candidate fleet of one or more mobile resources. The method 300 may be implemented by the optimizer module 204, as previously described with reference to FIGS. 1 and 2. It should be noted that in the following discussion, reference will be made, using like numerals, to the features described in FIGS. 1 and 2.

At 302, the optimizer module 204 receives one or more job postings from the incoming jobs module 202. As discussed previously, each job posting may include job requirements, such as capacity requirement, requested locations and times of pickup and dropoff, information of goods to be transported, delivery time window, priority level, and so forth. Other types of information, such as customer information and payment information, may also be included in the job posting.

At 304, the optimizer module 204 selects a subcontractor from a network of subcontractors associated with the enterprise, so as to determine if the attributes of the subcontractor's available mobile resources match the job requirements of the job posting. In some implementations, the network of subcontractors includes businesses that have registered with the dispatch system 122 as providers of logistics services. The registration may be performed via, for example, the subcontractor's interface 162.

At 306, the optimizer module 204 selects a candidate fleet of one or more available mobile resources associated with the subcontractor. The candidate fleet of mobile resources may include, for example, trucks, vans, cars, or any other types of transportation means owned or managed by the subcontractor. In some implementations, the candidate fleet of mobile resources is selected by parsing the subcontractor's list of mobile resources and selecting a subset of mobile resources with a total available capacity that at least equals the capacity requirement of the job posting. The available capacity data of each mobile resource may be retrieved from the stream database 222.

At 310, the optimizer module 204 determines whether the approximate delivery time of the candidate fleet fulfills the timing requirement of the job posting. For example, the timing requirement for the job may be next day delivery. If the candidate fleet will not deliver on time, it is eliminated from further consideration (i.e. not added to the suggestions list) and the process continues at step 314. If the approximate delivery time meets the timing requirement, the process continues at step 312. The approximate delivery time may be computed based on real-time status information (e.g., current location, average speed, etc.) retrieved from the stream database 222.

At 312, the optimizer module 204 determines a ranking score of the candidate fleet based on its attributes. The attributes may be static or dynamic. As discussed previously, static attributes may be specified by one or more access rules stored in the access rules store 220, while dynamic attributes may be retrieved from the stream database 222.

The ranking score may be determined based at least in part on a sorting parameter. A sorting parameter is a measure computed based on the attributes of the candidate fleet of one or more mobile resources. One exemplary sorting parameter is the number-of-empty-miles-saved. “Empty miles” refers to the distance traveled by a mobile resource with an empty load. For example, if a subcontractor's truck travels from point A to drop off goods at point B, and it accepts a job to pick up a new load at point B to deliver to point A, the truck is considered to have saved 100% empty miles. Candidate fleets of mobile resources that offer higher savings in empty miles may be awarded higher ranking scores.

Another exemplary sorting parameter is associated with an individual preference. For example, the logistics enterprise that manages the enterprise computing system 150 may allocate a higher selection priority to one or more preferred subcontractors from the network. These preferred subcontractors may, for example, have a special or longstanding business relationship with the logistics enterprise to warrant the higher priority. Candidate fleets associated with such preferred subcontractors may be awarded higher ranking scores.

Yet another exemplary sorting parameter is the overall carbon impact (or footprint). The overall carbon impact associated with a candidate fleet may be determined by, for example, calculating the number of mobile resources required to complete the delivery job (e.g., based on their available capacities, present locations, etc.), calculating the total travel distance of the mobile resources to the dropoff location (e.g., multiplying the number of trucks by the travel distance), calculating the average gas mileage of the mobile resources, etc. It is understood that other factors that contribute to carbon emissions may also be used to determine the carbon impact. Candidate fleets with lower carbon impact may be awarded higher rank scores.

Other sorting parameters may also be used to determine the ranking score. For example, the ranking score may be based at least in part on the proximity to the pickup location, or the approximate delivery (or arrival) time. The nearer the fleet is to the pickup location, the higher the rank score. Candidate fleets with higher service quality ratings may also be awarded higher rank scores. Service quality ratings may be based at least in part on past or historical customer ratings of the mobile resource and/or subcontractor.

At 314, the optimizer module 204 determines if there are other candidate fleets of the same subcontractor to be considered. If so, the next candidate fleet is selected and subsequently ranked by repeating steps 306, 310 and 312.

At 316, the optimizer module 204 determines if there are other subcontractors in the network of subcontractors to be considered. If so, the next subcontractor is selected and matched by repeating steps 304, 306, 310, 312 and 314.

At 318, the optimizer module 204 outputs the suggestions list of candidate fleets. The suggestions list may be sorted in accordance with the ranking scores of the candidate fleets. The suggestions list may then be provided to, for example, the job booking module 206 for further processing, as aforementioned.

An exemplary use case of an implementation of the present framework will now be described. Truck driver A works for logistics company X, which has registered with the dispatch system 122 as a subcontractor of enterprise M. Truck driver A carries a mobile phone 140, which has a driver's interface 142 that receives notifications of job postings from job booking module 206. The mobile phone 140 also updates the database 124 with real-time status information of the truck's location and available capacity.

Enterprise M receives a service request from a customer, and posts a job to system 101 via control interface 152. While en-route to a pick-up or drop-off location of a current job, the optimizer module 204 determines that attributes of the truck match requirements of the new job posting. The job booking module 206 then sends a notification of the new job posting to the mobile phone 140. With a simple push of the button on the mobile phone 140, truck driver A conveniently confirms acceptance and books the new job to fill up the available truck space with this new job. Without the opportunity to accept the new job, he would have to travel with the truck half-empty.

When truck driver A arrives at the scheduled pick-up location of the new job, goods are scanned and loaded into his truck. He receives another notification seeking his permission to share GPS data with the customer of enterprise M. He agrees by pushing an “Accept” button via the driver's interface 142. Starting from that moment, the truck becomes visible to the enterprise's customer via a customer interface that interacts with the system 101. The customer is waiting for the delivery and is quite happy to see the estimated arrival time being constantly updated via the customer interface. When truck driver A arrives at the pick-up point and unloads the goods, a delivery scan triggers another notification to be sent to his mobile phone 140, indicating that his GPS data sharing session has just ended.

Although the one or more above-described implementations have been described in language specific to structural features and/or methodological steps, it is to be understood that other implementations may be practiced without the specific features or steps described. Rather, the specific features and steps are disclosed as preferred forms of one or more implementations.

1. A computer-implemented method of job matching comprising:
receiving a job posting from an enterprise;
selecting a subcontractor from a network of subcontractors associated with the enterprise;
selecting a candidate fleet of one or more mobile resources associated with the subcontractor;
retrieving attributes of the candidate fleet from an in-memory database, wherein the attributes include dynamic attributes that are updated in real-time by the one or more mobile resources; and
if the attributes of the candidate fleet match requirements of the job posting, determining a ranking score based at least in part on the attributes.

2. A computer-implemented method of job dispatching comprising:
receiving a job posting from an enterprise;
storing attributes of mobile resources in a database, wherein the mobile resources are managed by a network of one or more subcontractors associated with the enterprise;
providing a list of one or more candidate fleets of the mobile resources, wherein the attributes of the one or more candidate fleets match requirements of the job posting; and
notifying at least one of the one or more candidate fleets of the job posting.

3. The computer-implemented method of claim 2 further comprising updating, by one or more mobile devices associated with the mobile resources, the attributes in real-time.

4. The computer-implemented method of claim 3 wherein updating the attributes in real-time comprises updating location data, sensor data, available capacity data, temporal data, graphical data, or a combination thereof.

5. The computer-implemented method of claim 3 wherein updating the attributes in real-time comprises updating, by one or more mobile phones associated with the mobile resources, the attributes in real-time.

6. The computer-implemented method of claim 2 wherein storing attributes of the mobile resources in the database comprises storing static attributes defined by one or more access rules.

7. The computer-implemented method of claim 6 wherein storing static attributes comprises storing a category of goods, vehicle information, preferences, unique identifier of a mobile device, driver's personal profile information, or a combination thereof.

8. The computer-implemented method of claim 2 further comprising seeking confirmation of job acceptance from the notified candidate fleet.

9. The computer-implemented method of claim 8 further comprising communicating information of the confirmation to a control interface of the enterprise.

10. The computer-implemented method of claim 2 wherein providing the list of the one or more candidate fleets comprises:
selecting a subcontractor from the network; and
selecting a candidate fleet of one or more mobile resources associated with the subcontractor, wherein the attributes of the candidate fleet match requirements of the job posting.

11. The computer-implemented method of claim 10 wherein selecting the candidate fleet of the one or more mobile resources associated with the subcontractor comprises selecting the candidate fleet with a total available capacity that at least equals a capacity requirement of the job posting.

12. The computer-implemented method of claim 10 wherein selecting the candidate fleet of the one or more mobile resources associated with the subcontractor comprises selecting the candidate fleet with an approximate delivery time that fulfills a timing requirement of the job posting.

13. The computer-implemented method of claim 12 further comprising computing the approximate delivery time based on the attributes retrieved from the database.

14. The computer-implemented method of claim 2 further comprising sorting the list of the one or more candidate fleets based at least in part on one or more sorting parameters.

15. The computer-implemented method of claim 14 wherein sorting the list of the one or more candidate fleets comprises sorting the list of the one or more candidate fleets based on number-of-empty-miles-saved.

16. The computer-implemented method of claim 14 wherein sorting the list of the one or more candidate fleets comprises sorting the list of the one or more candidate fleets based on overall carbon impact.

17. The computer-implemented method of claim 14 wherein sorting the list of the one or more candidate fleets comprises sorting the list of the one or more candidate fleets based on proximity to pickup location or approximate delivery time.

18. The computer-implemented method of claim 14 wherein sorting the list of the one or more candidate fleets comprises sorting the list of the one or more candidate fleets based on individual preference or service quality rating.

19. A non-transitory computer-readable medium having stored thereon program code, the program code executable by a processor to:
receive a job posting from an enterprise;
store attributes of mobile resources in a database, wherein the mobile resources are managed by a network of one or more subcontractors associated with the enterprise;
provide a list of one or more candidate fleets of the mobile resources, wherein the attributes of the one or more candidate fleets match requirements of the job posting; and
notify at least one of the one or more candidate fleets of the job posting.

20. A job dispatching system comprising:
a non-transitory memory device for storing computer-readable program code; and
a processor in communication with the memory device, the processor being operative with the computer-readable program code to:
receive a job posting from an enterprise;
store attributes of mobile resources in a database, wherein the mobile resources are managed by a network of one or more subcontractors associated with the enterprise;
provide a list of one or more candidate fleets of the mobile resources, wherein the attributes of the one or more candidate fleets match requirements of the job posting; and
notify at least one of the one or more candidate fleets of the job posting.
